(19) United States
(12) Patent Application Publication
(10) Pub. No.: US 2012/0075980 A1
(43) Pub. Date: Mar. 29, 2012

(54) HIGH-RESOLUTION READ HEAD FOR AN OPTICAL DISK

(75) Inventors: Marieke Laporte-Richard, Sassenage (FR); Mickael Brun, Eybens (FR)

(73) Assignee: Commissariat A L'Energie Atomique et Aux Energies Alternatives, Paris (FR)

(21) Appl. No.: 13/257,012

(22) PCT Filed: Mar. 16, 2010
(86) PCT No.: PCT/FR10/50468

§ 371 Date: Dec. 9, 2011

(30) Foreign Application Priority Data
Mar. 17, 2009 (FR) 0951683

(51) Int. Cl. G11B 7/1372; B82Y 10/00

(52) U.S. Cl. 369/112.16; 977/762; G9B/7.12

(57) ABSTRACT

The instant disclosure relates to a high resolution read head for an optical disk, including a monochromatic laser source; a radial polarization polarizer; an annular diaphragm that is opaque at the center and periphery thereof; an optical system for shaping the beam; and a light-concentrating microcomponent including a hemispherical lens, at the focal point of which a nanowire is arranged, and which is orthogonal to the plane of said lens, said nanowire being capped with a metal half-bead.

### TECHNICAL FIELD

The present invention relates to the field of optical disks, and more specifically to a high-resolution pick-up for an optical disk.

### DISCUSSION OF PRIOR ART

The current storage capacity of optical disks (CD, then DVD, and now BluRay) is linked to the size of the reading spot, and thus submitted to the Rayleigh criterion: p=λ/NA where p is the radius of the light spot, λ the wavelength, and NA the numerical aperture equal to 2 n sin θ where n is the optical index of the material where the optical wave propagates, and θ the maximum angle of aperture of the lens system providing the focusing. To increase the storage capacity of this type of support, several options have been followed.

Options escaping from the Rayleigh criterion:
SuperResolution: local modifications of the properties of the material forming the optical disk are used to decrease the size of the read/write spot on the disk for a same size of the light spot illuminating the disk;
Holography: the information is not only stored on two surface dimensions of the disk but is also distributed across an entire volume xyz; this solution raises issues of fast disk replication since said replication can no longer be performed by molding and requires an optical writing of each disk;
Multiple-level writing: From two to several bidirectional information layers are stacked on a same support. The different layers will be successively read by adjustment of the focusing.

Options improving the Rayleigh criterion:
Wavelength decrease: wavelengths in the close UV range rather than infrared are used, for example, 405 nm in the so-called “BluRay” system;
Increase of the numerical aperture: a current approach is to use a solid immersion lens. The beam is focused onto the planar surface of a hemispherical lens (SIL) by means of an optical system of large numerical aperture. Numerical aperture NA is equal to the numerical aperture of the beam illuminating the hemispherical lens multiplied by the optical index of the material forming the hemispherical lens (SIL): NA=n_{SIL}*NA_{inc}, with NA_{inc} designating the numerical aperture of the incident beam. This system can be further improved by the use of an adapted illumination (radial polarization and annular masking of the beam). In optimal illumination conditions (adapted polarization, judicious masking and wavelength 405 nm, NA_{inc}=0.85), the spot at the focus of the hemispherical lens has a mid-diameter on the order of 180 nm.

This last solution presently is one of the most promising but, as can be seen, it remains limited, with current wavelengths (405 nm), to spot dimensions on the order of 180 nm, that is, it is difficult to analyze patterns smaller than this dimension on an optical disk.

### SUMMARY

An object of an embodiment of the present invention is to provide an optical pick-up system adapted to the reading of optical disks, enabling to further minimize the spot size.

Thus, an embodiment of the present invention provides a high-resolution pick-up for an optical disk, comprising a monochromatic laser source; a polarizer of radial polarization; an annular diaphragm opaque at the center and at the periphery; an optical beam forming system; and an optical concentration microcomponent comprising a hemispherical lens having a nanowire, orthogonal to the plane of this lens, arranged at its focus, this nanowire being topped with a metal half-ball.

According to an embodiment of the present invention, the hemispherical lens has a diameter approximately ranging from 1 to 5 μm.

According to an embodiment of the present invention, the nanowire is a silicon nanowire having a length from 10 to 100 nm, preferably from 30 to 60 nm, and a diameter from 10 to 60 nm, preferably from 30 to 40 nm.

According to an embodiment of the present invention, the metal half-ball is made of gold.

According to an embodiment of the present invention, the light reflected by the optical concentration microcomponent is sampled by a splitter towards a photodetector.

According to an embodiment of the present invention, the pick-up is capable of reading patterns with a size approximately ranging from 20 to 50 nm from an optical disk.

According to an embodiment of the present invention, the pick-up comprises a device for controlling the distance between the pick-up and the optical disk.

According to an embodiment of the present invention, the pick-up is capable of operating at a wavelength ranging between 400 and 520 nanometers.

### BRIEF DESCRIPTION OF THE DRAWINGS

The foregoing and other objects, features, and advantages of the present invention will be discussed in detail in the following non-limiting description of specific embodiments in connection with the accompanying drawings, among which:

FIG. 1 shows an optical concentration microcomponent used in an embodiment of the present invention;

FIG. 2 shows an optical diagram of an optical disk reading system according to an embodiment of the present invention;

FIGS. 3 to 8 show successive steps of an example of manufacturing of the optical concentration microcomponent; and

FIG. 9 shows a step of an example of manufacturing of the optical concentration microcomponent.

### DETAILED DESCRIPTION

For clarity, the same elements have been designated with the same reference numerals in the different drawings and, further, as usual in the representation of integrated circuits, the various drawings are not to scale.

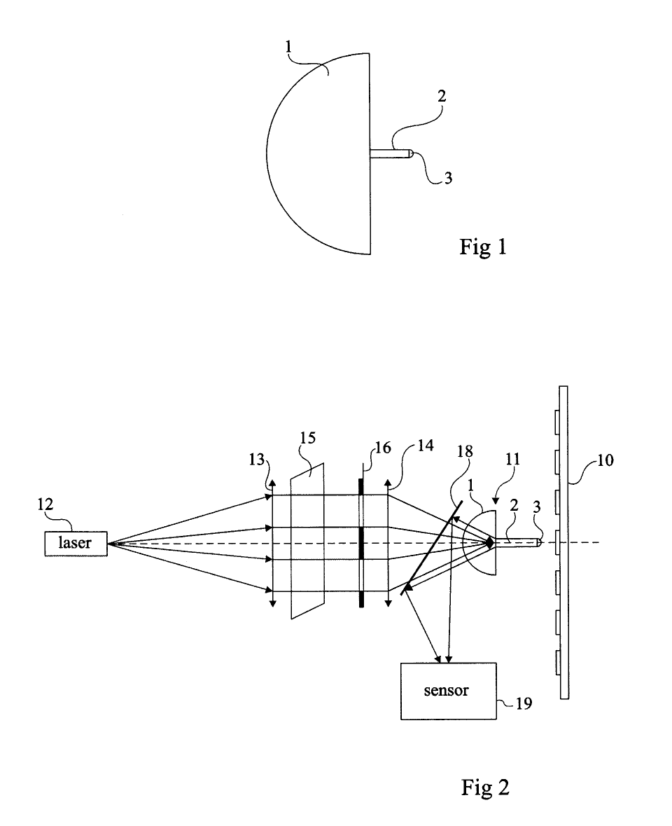

FIG. 1 shows an optical concentration microcomponent used according to an embodiment of the present invention. This microcomponent comprises a hemispherical lens or solid immersion lens 1 having, on its planar surface, a small element of nanometric size, preferably a piece of nanowire 2 with an end comprising a small mechanical pellet 3, preferably hemispherical, of same radius as the nanowire. It will be shown that such an optical concentration nanowire has significant advantages in the context of a use for an optical disk pick-up.

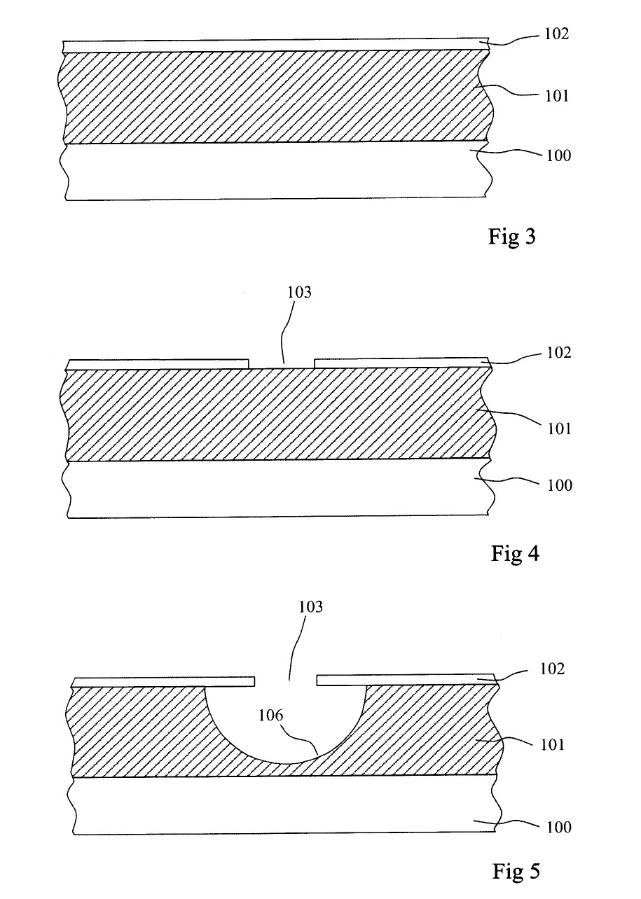

FIG. 2 shows a high-resolution optical pick-up system for an optical disk.

The surface of the optical disk is shown to the right of the drawing and is designated with reference numeral 10, it conventionally comprises bumps and holes to be identified.

The assembly comprises an optical concentration microcomponent 11 such as shown in FIG. 1. The hemispherical lens is illuminated by a beam originating from a laser 12, widened and transformed into a parallel beam by an optical forming system 13, shown as a single lens and focused to the focus of hemispherical lens 1 by a focusing lens 14 also shown as a single lens. A radial polarization polarizer 15, for example formed of rectilinear polarization elements arranged in sectors, is arranged in the beam, preferably at a location where it is parallel.

An annular diaphragm 16 is also arranged on the way of the beam, this diaphragm having an internal radius r1 and an external radius r2. It enables to mask all or part of the beams having an angle of incidence on the pick-up greater than the numerical aperture (which will be chosen to be as high as possible, for example, equal to 0.85). It also enables to mask beams having an angle of incidence smaller than the total internal reflection angle for the interface between the material of the hemispherical lens, for example, silica. The following radiuses are thus selected:

r1=f_{obj}*tan [Arcsin(1/n_{SIL})],

r2=f_{obj}*tan [Arcsin(NA)],

where:
f_{obj} is the focal distance of the focusing lens;
n_{SIL} is the optical index of the material in which the hemispherical lens (SIL) is formed;
NA is the numerical aperture of the focusing lens. In the preferred embodiment, this numerical aperture is equal to 0.85.

The diaphragm may be placed after optical system 14, in which case

r1=d*tan [Arcsin(1/n_{SIL})],

r1=d*tan [Arcsin(NA)],

where d designates the distance between the diaphragm and the planar surface of the hemispherical lens.

A splitter 18 enables to direct the light reflected by microcomponent 11 after having interacted with the optical disk towards a photo-sensor 19 capable of detecting the intensity of the reflected beam.

With such a system, by selecting:
an illumination light within a wavelength range from 400 to 520 nm,
a silicon nanowire 2 having a length ranging from 10 to 100 nm, preferably from 30 to 60 nm, and a diameter ranging from 10 to 50 nm, preferably from 20 to 30 nm,
a gold half-ball 3,
a silica solid immersion lens 1,
   a light spot having a size approximately ranging from 20 to 30 nm, that is, much smaller than the size of the light spot obtained with the sole hemispherical lens, can be obtained at a few nanometers from the first gold ball. This thus enables to analyze patterns of the same order of magnitude on the optical disk, that is, patterns which may have dimensions as small as 20 nm. As a result, optical disks with a very high data concentration can be read from.

It can further be acknowledged that in such conditions, a very high output efficiency, that is, a contrast between the raised portions and the hollow portions on the optical disk that may be greater than 10%, is obtained. It can also be acknowledged that the amount of reflected light is very large with respect to the injected light. For example, with 1 watt of light sent into the ring delimited by the annular diaphragm, powers on the order of 700 mW are obtained (for example, 730 mW for raised surfaces and 700 mW for hollow surfaces).

It is considered that the system is especially based on evanescent waves, and the metal half-ball of the optical concentration microcomponent used according to the invention will thus be placed at a distance from the optical disk much smaller than the illumination wavelength, for example, at a distance approximately ranging from 5 to 200 nm. A device for controlling the distance between the pick-up and the optical disk will further preferably be provided.

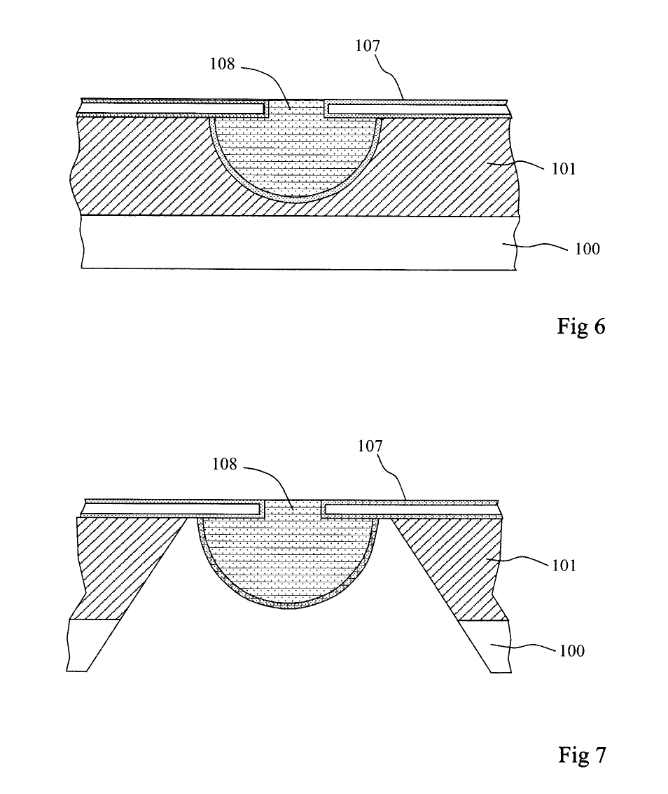

A method for forming the above-mentioned microcomponent is provided by the following steps, typical of the microelectronics industry, and detailed in FIGS. 3 to 8. These drawings show cross-section views of the microcomponent at different steps of its manufacturing.

In a first step illustrated in FIGS. 3 and 4, a stack comprising the following elements is formed on a first surface of a substrate 100 of a first material:
a first layer 101 of a second material capable of being isotropically etched. It should be noted that this layer could have been the actual substrate 100;
a second layer 102 formed by at least one third material. This second layer must be both opaque to light and resistant to the isotropic etching of the lower layer. Of course, this single layer may be replaced with a stack of layers to obtain the desired effects.

An opening of nanometric dimensions 103 is then formed in this second layer.

The first material may be silicon, the second material may be silicon or silicon oxide, and the third material may be, according to the sub-layers, silicon nitride, silicon oxide, and a metal such as gold or platinum.

In a second step illustrated in FIG. 5, a cavity 106 of substantially hemispherical shape is formed through the opening of the second layer in the substrate by isotropic etching. A self-alignment of the focus with respect to opening 10 is thus obtained.

In a third step illustrated in FIG. 6, a first conformal deposition 107 of a fourth material which may be silicon nitride is performed, after which a thick layer 108 of a material of high optical index such as silicon oxide or hafnium oxide is deposited in the hemispherical cavity to form the spherical sector of the immersion lens. A second planarization is then performed on this last deposited layer.

In a fourth step illustrated in FIG. 7, the substrate portion covering spherical sector 108 is suppressed by anisotropic etching on the rear surface of the substrate to disengage this spherical sector.

In a fifth step illustrated in FIG. 8, an object 109 of nanometric dimensions is formed at the center of the opening of the second layer. This step may be followed by a step of growth of a nano-object of strongly anisotropic shape such as a carbon nanotube or nanowire in the opening on the focus area.

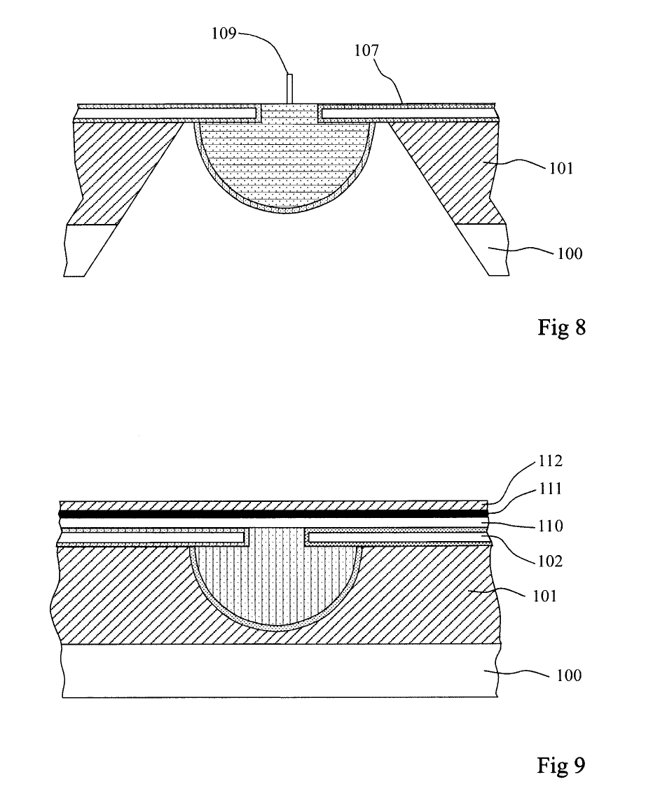

As an example, the step of forming of the nano-object may be carried out from an etch process in an additional layer or multilayer structure deposited or transferred by layer transfer after structuring of the lens. In the case of a deposited layer, the layer or the multilayer structure is directly structured to form the nano-object. Said nano-object is generally polycrystalline and its form factor is of little importance with this technique. To obtain a single-crystal object, the layer transfer method is better adapted. A method for transferring a layer by molecular bonding on a planar surface formed of several materials is described in patent application US2008/079123. As illustrated in FIG. 9, the transferred layer may be formed of a sandwich comprising a growth layer 110 which may be made of silicon, a catalyst layer 111 which may be made of gold, and a protection layer 112 which may be made of the lower layer oxide. A single-crystal nanowire can then be directly etched in the growth layer. This etching may also be followed after clearing of the residual protection layer, by a step of growth of the nanowire from the gold catalyst or according to known CVD-type procedures. It is thus possible to obtain high form factors.

1. A high-resolution pick-up for an optical disk, comprising:
a monochromatic laser source;
a polarizer of radial polarization;
an annular diaphragm opaque at the center and at the periphery;
an optical beam forming system; and
an optical concentration microcomponent comprising a hemispherical lens having a nanowire, orthogonal to the plane of this lens, arranged at its focus, this nanowire being topped with a metal half-ball.

2. The high-resolution pick-up of claim 1, wherein the hemispherical lens has a diameter approximately ranging from 1 to 5 μm.

3. The high-resolution pick-up of claim 1, wherein the nanowire is a silicon nanowire having a length from 10 to 100 nm, preferably from 30 to 60 nm, and a diameter from 10 to 60 nm, preferably from 30 to 40 nm.

4. The high-resolution pick-up of claim 1, wherein the metal half-ball is made of gold.

5. The high-resolution pick-up of claim 1, wherein the light reflected by the optical concentration microcomponent is sampled by a splitter towards a photo-sensor.

6. The high-resolution pick-up of claim 1, capable of reading patterns with a size approximately ranging from 20 to 50 nm from an optical disk.

7. The high-resolution pick-up of claim 1, comprising a device for controlling the distance between the pick-up and the optical disk.

8. The high-resolution pick-up of claim 1, capable of operating at a wavelength ranging between 400 and 520 nanometers.
